(19) United States
(12) Patent Application Publication
(10) Pub. No.: US 2003/0105724 A1
(43) Pub. Date: Jun. 5, 2003

(54) Method and system for settling with security key

(76) Inventors: Masahiro Tsunekawa, Yokohama (JP); Koji Ito, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/235,808

(22) Filed: Sep. 6, 2002

(30) Foreign Application Priority Data
Dec. 5, 2001 (JP) 2001-371219

(51) Int. Cl. G06F 17/60

(52) U.S. Cl. 705/65

(57) ABSTRACT

Before a service user start to enjoy a service, a settlement amount is transferred to a bank account for settlement from a bank account of the service user. A settlement system generates a security key B and sends the key to the service user, and registers the security key and settlement information in a settlement information file. Upon the completion of enjoying the service, the service user delivers the security key B to a service provider, while the service provider instructs the transfer to the bank account of the service provider by designating the security key B. The settlement system transfers a settlement amount to the bank account of the service user from the bank account for settlement, if the security key received is found to have been registered in a settlement information file.

### BACKGROUND OF THE INVENTION

The present invention relates to a method for settling electronic business transactions (hereinafter referred to as the “e-commerce”) executed through a network such as the Internet, and more particularly to a settling method using a security key.

The e-commerce executed through a network such as the Internet has been offering problems that “a service user cannot enjoy a service despite that the user has completed the payment for it”, “payment is not done despite that a service user started to enjoy a service”, or the like since a service provider and a service user do not meet each other. In addition, personal information such as a credit card number associated with the settling measures may be made open to a service provider.

As a means to solve the above-stated problem, it is necessary to authenticate a service user and a service provider as well as to complement the credibility by means of a reservation action. Technologies regarding the e-commerce include the one disclosed in Japanese Patent Laid-open No. 2001-101271, for example. With the technology of Japanese Patent Laid-open No. 2001-101271, a settling method is proposed, wherein a third-party authenticating or settling agent is laid between a service user and a service provider, a settlement is made between the service user and the agent, and such agent executes the payment to the service provider a certain period after the shipment of goods.

### SUMMARY OF THE INVENTION

With the prior art as described in the above, it is possible to prevent the leakage of personal information concerning a settlement, since a third-party authenticating or settling agent performs the settlement on behalf of a service user, but such prior art has a problem that the service user cannot directly instruct the payment, since the final settlement is entrusted to an agent. This will not cause any problem in a case of “goods” of downloaded contents and the like, where the transaction is deemed to have been completed at the time of the shipment of the goods. However, for services rendered in a lodging facility such as a hotel, such a method to make the settlement after “a certain period” is not suitable, since only a service user can judge the completion of transaction, and the payment amount can only be fixed at the time of the completion of services (at the time of checking out).

In addition, with a method where a settlement is executed on behalf by a third-party authenticating or settling agent, the method can hardly be applied to a business carried out by targeting the unspecified number of users, since it is necessary that a service user has to register his or her personal information with the agent and also to delegate authority relating to the payment to the agent.

An object of the present invention is to provide a settlement technique which enables to fix a settling timing mainly for the convenience of a service user.

The present invention relates to a settling technique, wherein: after a settlement amount arising out of a service provision transaction in an e-commerce between a service provider and a service user is fixed, and before the service is provided to the service user by the service provider; the settlement amount is electronically moved to a bank account owned by a financial institution from a bank account of the service user, a security key is generated to be transmitted to a computer of the service user; the security key and other settlement information related to transaction concerned are registered in a memory means; the security key is transferred to a computer of the service provider from a computer of the service user after completion of the service provision; and the settlement amount is electronically moved to the bank account of the service provider from the bank account owned by the financial institution if the security key received from the computer of the service provider is found to be the one registered in the memory means concerned.

### BRIEF DESCRIPTION OF THE DRAWING

FIG. 1 is a configuration diagram showing a settlement system according to an embodiment.

FIG. 2 is a diagram showing a data format of the settlement system according to the embodiment.

FIG. 3 is a diagram showing processing procedures of the settlement system according to the embodiment.

FIG. 4 is a diagram, referring to the settlement system according to the embodiment, showing processing procedures of a case where a service user notified to cancel the service before the user starts to enjoy the service.

### DESCRIPTION OF THE PREFERRED EMBODIMENT

Hereinafter, an embodiment according to the present invention will be described with reference to the drawings.

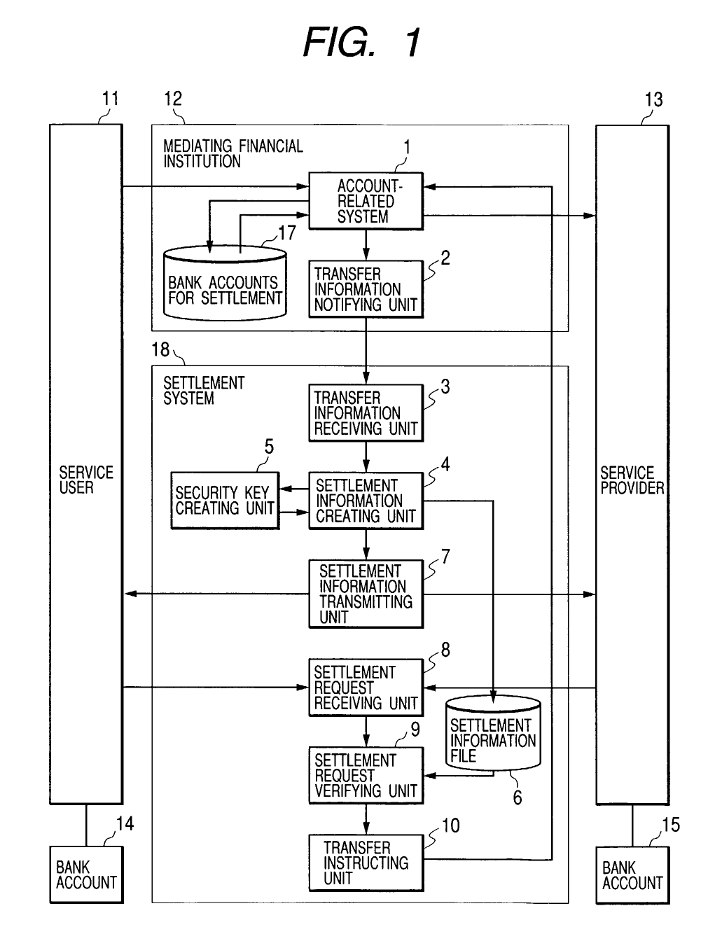

FIG. 1 is a configuration diagram showing a settlement system of the preferred embodiment. The system comprises a service user 11, a service provider 13, a mediating financial institution 12 and a settlement system 18. The service user 11 is a computer for the service user. The service user owns an electronic bank account 14 in a mediating financial institution or an another financial institution. The service provider 13 is a computer for the service provider. The service provider owns an electronic bank account 15 in a mediating financial institution or an another financial institution. The mediating financial institution 12 is an information processing system of the mediating financial institution and has an account-related system 1 and bank account(s) for settlement 17. The bank account(s) for settlement 17 are the bank accounts owned by the mediating financial institution and are the electronic bank account(s) in which a settlement amount transferred by the service user 11 is temporarily kept as a deposit.

The settlement system 18 is an information processing system which works in conjunction with the mediating financial institution 12, and has processing units marked with reference numerals 3 to 5 and 7 to 10 and the settlement information file 6 as shown in the drawing. The processing units illustrated are all application programs executed by the mediating financial institution 12 or the settlement system 18. The settlement information file 6 incorporates settlement information that is created according to each transaction, in which a transfer is made to the bank account for settlement 17 from the service user 11, in the storing device of the settlement system.

When the service user 11 executes a transfer by using an ATM or the Internet to the bank account for settlement 17 of the mediating financial institution 12, a transfer information notifying unit 2 which received a notification of transfer from the account-related system 1 of the mediating financial institution 12 then notifies the settlement system 18 of a transfer amount, a service provider's bank account, the name of a payer, a bank account of a service user, etc..

Upon receiving the transfer information by a transfer information receiving unit 3, the settlement system 18 creates settlement information in a settlement information creating unit 4 and registers the information in the settlement information file 6. At this time, the settlement system creates security keys having different authorities to be delivered to the service user 11 and the service provider 13 in a security key creating unit 5. The term “different authorities” implies that a security key for the service user has an authority to transfer the settlement amount in the bank account for settlement 17 to the bank account 15, and a security key for the service provider has an authority to refund the settlement amount in the bank account for settlement 17 to the bank account 14. Thereafter, the settlement system 18 creates settlement information containing the security keys thus created, a bank account name of the service user, a bank account name of the service provider, an amount to be transferred, etc.

Thereafter, a settlement information transmitting unit 7 transmits the security key for the service user to the service user 11, and it also transmits settlement information excluding the bank account name of the service user, and the security key for the service provider to the service provider 13.

Where the service user has a service from the service provider and is satisfied with the contents of the service the service user 11 instructs the settlement to a settlement request receiving unit 8 via the service provider 13. At this time, the service user 11 also notifies the security key for the service user 11.

Upon receiving an instruction from the service user 11, the settlement system 18 reads settlement information in question from the settlement information file 6 in a settlement request verifying unit 9, and verifies the information thus read out with the security key delivered by the service user 11. If the verification has revealed that the transfer instruction is made by the service user 11, the settlement system 18 instructs the account-related system 1 of the mediating financial institution to execute the transfer to the service provider via a transfer instructing unit 10.

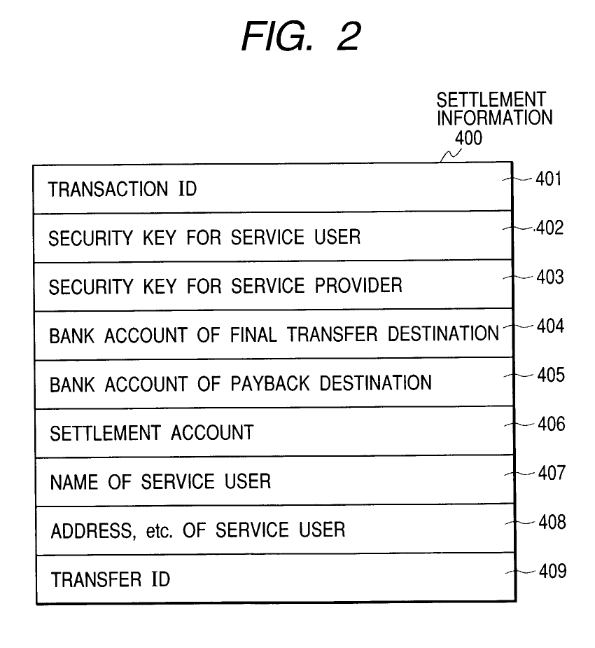

FIG. 2 is a diagram showing data formats for respective settlement information 400 to be stored in the settlement information file 6. The settlement information 400 includes: a transaction ID 401 which is used to identify a transaction; a security key for service user 402 which is to be given to the service user; a security key for service provider 403 which is to be given to the service provider; a bank account of final transfer destination 404 which indicates an account number of the bank account 15 of the service provider; a bank account of payback destination 405 which indicates, when a payback occurs, an account number of the bank account 14 of the service user in which the service user receives the payback; a settlement account 406; a name of the service user 407; an address of the service user 408; and a transfer ID 409 which is to be given to such transaction.

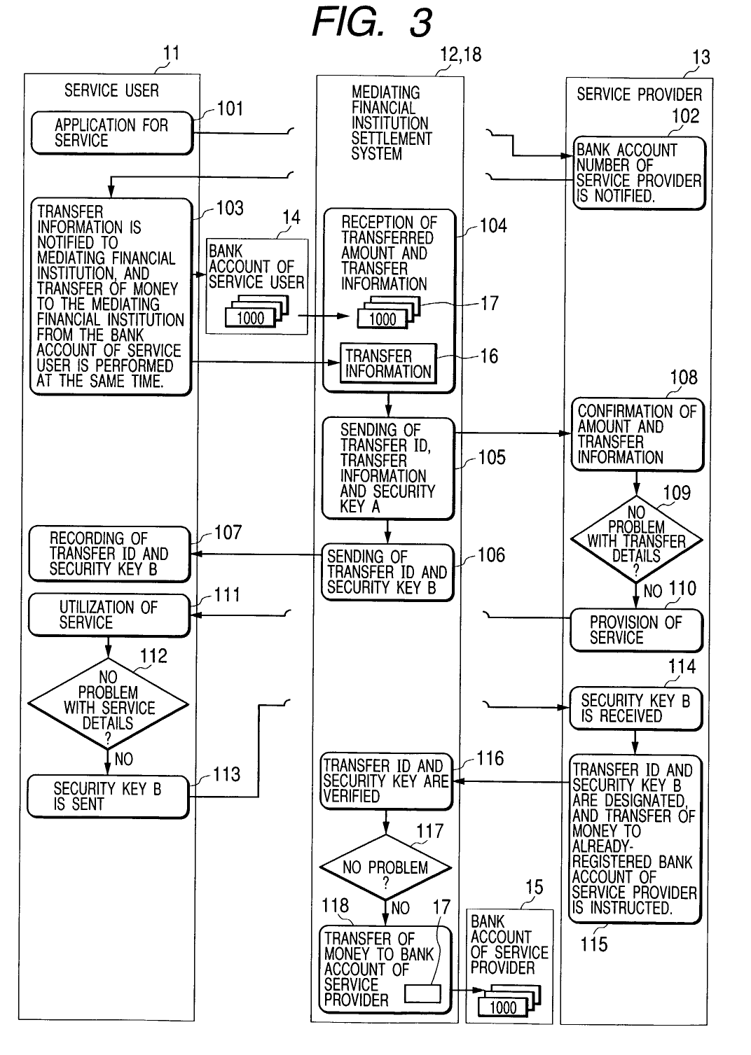

FIG. 3 is a diagram showing processing procedures of a settlement system of the embodiment. A service user 11, when he or she determines to use a service, for example, of purchasing goods through the Internet and the like, applies for the service to a service provider 13 (Step 101). The service provider 13 which received the application transmits information on the payment, a bank account number to which the transfer is made (a bank account number of the service provider), etc. to the service user 11 (Step 102). If the bank account number of the service provider will cause a problem in terms of the security, an identification number, which will be registered in the mediating financial institution 12 in advance, to be converted to the bank account number may be used alternatively.

The service user 11 who received a notification transmits transfer information 16 including a transaction ID, a bank account number of the service provider (or its identifier), a bank account number of the service user, the settlement amount, the address and the name of the service user, etc. to the mediating financial institution 12, and also instructs the institution 12 to execute a transfer to the mediating financial institution 12 from the bank account 14 of the service user (Step 103).

The account-related system 1 of the mediating financial institution 12 which received the transfer information 16 and the instruction to transfer the payment will check whether, for example, the bank account 14 which corresponds to the bank account number of the service user exits or not; if it does, whether the bank account 14 has an outstanding amount for the settlement amount or not; and whether the bank account 15 of the service provider exists or not. In case the bank account 14 is of an another financial institution, the check can only be made whether the bank account 15 exists or not, since the action is only taken to deposit the settlement amount to the bank account for settlement 17. If the instruction is correct, the settlement amount is paid from the bank account 14 and is transferred to the bank account for settlement 17. Thereafter, the transfer information 16 is delivered to the transfer information receiving unit 3 of the settlement system 18 via a transfer information notifying unit 2 (Step 104). All pieces of processing in the step 104 are executed by computer processing and by transmitting information between computers, thus requiring no intervention of human beings.

The settlement information creating unit 4 gives a transfer ID which is unique to such transaction. The security key creating unit 5 creates a security key A which is to be sent to the service provider and a security key B which is to be sent to the service user. The security key consists of an array of bits which are created according to transactions by generating random numbers, etc., and corresponds to a secret key to be generated in cryptoprocessing. Then, the settlement information creating unit 4 registers the transfer information 16 to which the transfer ID given in the above, the security key A and the security key B are added in the settlement information file 6 as the settlement information 400. If the bank account number of the service provider is another identifier, then a bank account converted is registered.

Next, the settlement information transmitting unit 7 sends the transfer ID given in the above, the security key A and the transfer information 16 excluding the bank account of service user to the service provider 13 (Step 105), and also sends the transfer ID and the security key B to the service user 11 (Step 106).

The service user 11 who received the transfer ID and the security key B records the transfer ID and the security key B in a storing device of the computer (Step 107). On the other hand, an operator for the service provider 13 which received the transfer ID, the security key A and the transfer information 16 confirms the transfer amount, the bank account to which the transfer is made (a bank account of the service provider) which are contained in the transfer information 16 (Step 108). The operator judges whether there is a problem in the details or not (Step 109), and if there is no problem, the operator provides the service to the service user (Step 110). The transfer ID and the security key A are stored in the storing device of the service provider 13. A user for the service user 11 who received a service in the Step 111 judges whether there is any problems in the service content or not (Step 112). If there is no problem, the service user 11 sends the security key B to the service provider 13 via an electronic transfer means such as an e-mail (Step 113).

The service provider 13 which received the security key B designates a corresponding transfer ID and a security key B, and instructs the settlement system 18 to transfer the payment to the bank account 15 of the service provider (Step 115). A settlement request receiving unit 8 receives the instruction. A settlement request verifying unit 9 refers to corresponding settlement information 400 in the settlement information file 6, to check whether the transfer ID and the security key B received has been registered or not (Step 116). If they have been registered (NO for Step 117), a transfer instructing unit 10 instructs the account-related system 1 to pay the settlement amount 406 from the bank account for settlement 17, and transfer the amount to the bank account 15 of the service provider (Step 118). All pieces of processing in the step 118 are executed by computer processing and by transmitting information between computers, thus requiring no intervention of human beings.

As seen from the above-described processing procedures, the service user can enjoy a reliable e-commerce service since the user delivers in the Step 113 the security key B to the service provider after enjoying the service in the Step 111 and executes a de facto payment. On the other hand, for the service provider, the payment of the settlement amount 406 is guaranteed as far as the provider retains its own security key A. In a case where the service user lost the security key B, it is possible for the settlement system to transfer the settlement amount 406 to the bank account 15 from the bank account for settlement 17, under the agreement of the service user, by using the transfer ID and the security key A owned by the service provider. A delay in the dispatch of the security key B to the service provider 13 from the service user 11 will bring a disadvantage to the service provider, but it will be safer that the settlement amount should be paid to the service provider after the negotiation between both parties regarding the transaction has been finalized.

It should be noted, in the Step 113, the processing procedures are so arranged that the security key B is sent to the service provider 13 and the service provider 13 requests the settlement system 18 to execute a transfer. However, it may be so arranged that, in the Step 113, the service user 11 sends the transfer ID and the security key B to the settlement system 18, whereby an instruction of transfer to the service provider 13 is made. Even in such a case, the processing in Steps 116 to 118 remains the same.

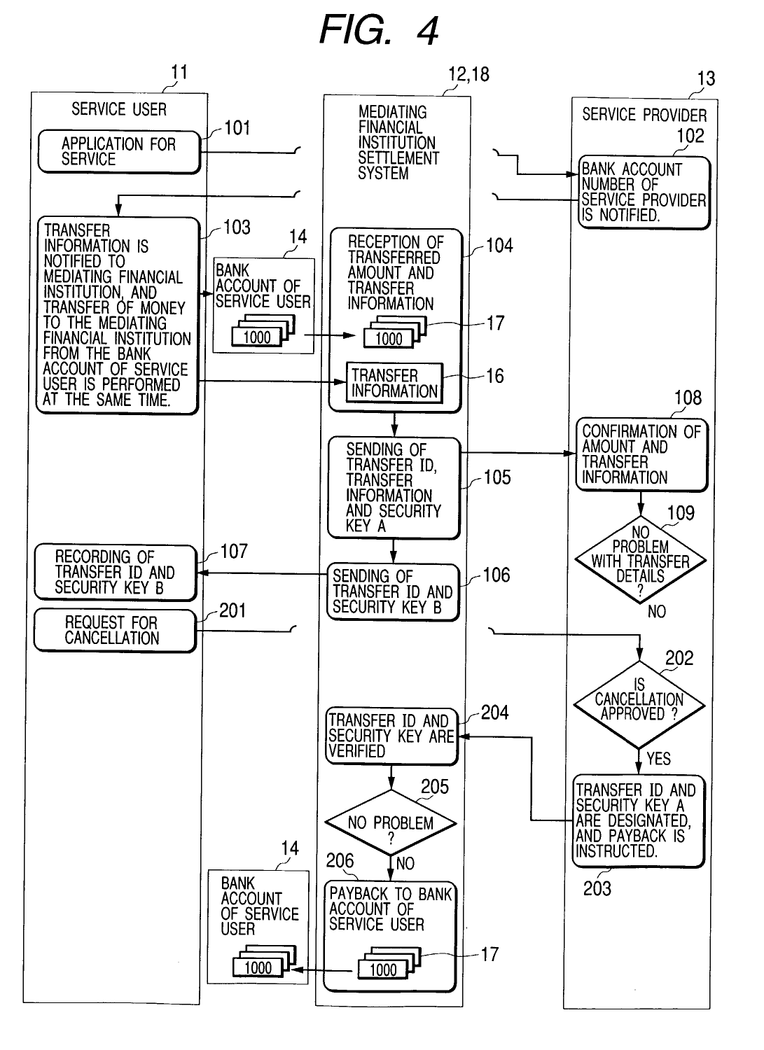

FIG. 4 is a diagram showing processing procedures for a case where, in the settlement system according to the embodiment, a service user notified a cancellation of service before the user is serviced. Same processing procedures as those in FIG. 3 are applied to Steps 101 to 109. In a Step 201, the service user requests a cancellation to a service provider. The service provider which received the request for cancellation judges whether the cancellation is possible or not (Step 202). If the cancellation is possible, the service provider 13 designates the corresponding transfer ID and security key A, and instructs a settlement system 18 to execute refunding (Step 203).

The settlement request receiving unit 8 receives the instruction, and the settlement request verifying unit 9 refers to the corresponding settlement information 400 in a settlement information file 6 to check whether the transfer ID and the security key A received have been registered or not (Step 204). If they have been registered (NO for Step 205) the transfer instruction unit 10 instructs the account-related system 1 to pay the settlement amount 406 from the bank account for settlement 17, and executes the refunding to the bank account 14 of the service user (Step 206). As stated in the above, if the service user has not enjoyed the service, the transaction can be cancelled, and the settlement amount once transferred to the bank account for settlement 17 is refunded to the bank account 14 of the service user.

Processing procedures for a case where a payment amount is determined after a service user has enjoyed a service will be described below. Same processing procedures as describe above are applied to Steps 101 to 111, and the service user 11 transfers the basic charge for the service to be received to the bank account for settlement 17. The service user 11, after having enjoyed the service in Step 111, designates a transfer ID and transfers an additional fee to the bank account for settlement 17 if there is no problem in the service (NO for Step 112). The settlement information creating unit 4 registers the transfer of the additional fee in a corresponding settlement information 400 in a settlement information file 6. The settlement information transmitting unit 7 notifies the service provider 13 of the transfer of the additional fee. Subsequent Steps 108 and 109 and Steps 113 to 118 are the same as those stated in the above. If the service user neglects the additional fee and tries to settle the basic charge only, the security key B will not be sent to the settlement system 18 since the service provider will not be satisfied, and therefore, the transaction will not be settled.

As described in the above, according to the present invention, in a settlement of an e-commerce executed through a network such as the Internet, the timing of settlement can be determined at the discretion of a service user, since a settlement can only be completed when a service user has delivered a security key to a service provider, thus enabling to realize a reliable e-commerce service. On the other hand, for the service provider, the payment of a settlement amount can be guaranteed as far as the provider retains its own security key. In addition, it is not necessary for a service user to register his or her private information in a financial institution in advance.

What is claimed is:

1. A settling method for settling with a security key comprising the steps of:
after a settlement amount has been fixed through an e-commerce as a result of a service providing transaction between a service provider and a service user, electronically moving said settlement amount to a bank account of a financial institution from a bank account of said service user before the said service provision is executed to said service user from said service provider, generating a security key to transmitted the key to a computer of said service user, and then registering said security key and other settlement information related to such transaction in a memory means; and
after said service provision has been executed, electronically moving said security key to the computer of said service provider from the computer of said service user, and if said security key received from the computer of said service provider is found to have been registered in said memory means, electronically moving said settlement amount to the bank account of said service provider from the bank account owned by said financial institution.

2. A settling method for settling with security keys comprising the steps of:
after a settlement amount has been fixed through an e-commerce as a result of a service providing transaction between a service provider and a service user, electronically moving said settlement amount to a bank account of a financial institution from a bank account of said service user before the said service provision is executed to said service user from said service provider, generating a first security key for the service provider and a second security key for the service user, sending said first security key to the computer of said service provider and sending the second security key to the computer of said service user respectively, and then registering said first security key, said second security key and other settlement information related to such transaction in a memory means; and
after said service provision has been executed, electronically moving said second security key to the computer of said service provider from the computer of said service user, and if said second security key received from the computer of said service provider is found to have been registered in said memory means, electronically moving said settlement amount to the bank account of said service provider from the bank account owned by said financial institution.

3. A settling method for settling with security keys as claimed in claim 2, wherein, when a cancellation of said transaction along with said first security key is made by the computer of said service provider, said settlement amount is electronically moved to the bank account of said service user from the bank account of said financial institution, if said first security key received is found to have been registered in said memory means.

4. A settling method for settling with security keys as claimed in claim 2 further comprising the steps of:
after said service provision has been executed, electronically moving an additional amount to the bank account of said financial institution from the bank account of said service user, registering said additional amount additionally as said settlement information, and if said second security key received from the computer of said service provider is found to have been registered in said memory means, electronically moving an amount that is obtained by adding said additional amount to said settlement amount to the bank account of said service provider from the bank account of said financial institution.

5. A method that is executed by a settlement system after a settlement amount has been fixed through an e-commerce as a result of a service providing transaction between a service provider and a service user, said settling method for settling with a security key comprising the steps of:
before said service provision is executed to said service user from said service provider, receiving transfer information related to said transaction to confirm the existence of the bank account of said service provider contained in said transfer information, receiving said settlement amount transferred from the bank account of said service user in a bank account for settlement, generating a security key to transmit the key to a computer of said service user, and then registering said security key and other settlement information related to such transaction in a memory means; and
after said service provision has been executed, if said security key received from the computer of said service provider is found to have been registered in said memory means, transferring said settlement amount to the bank account of said service provider from said bank account for settlement.

6. A method that is executed by a settlement system after a settlement amount has been fixed through an e-commerce as a result of a service providing transaction between a service provider and a service user, said settling method using security keys comprising the steps of:
before said service provision is executed to said service user from said service provider, receiving transfer information related to said transaction to confirm the existence of the bank account of said service provider contained in said transfer information, receiving said settlement amount transferred from the bank account of said service user in a bank account for settlement, generating a first security key for the service provider and a second security key for the service user respectively, sending said first security key to a computer of said service provider and sending the second security key to a computer of said service user respectively, and then registering said first security key, said second security key and other settlement information related to such transaction in a memory means; and
after said service provision has been executed, if said second security key received from the computer of said service provider is found to have been registered in said memory means, transferring said settlement amount to the bank account of said service provider from said bank account for settlement.

7. A method as claimed in claim 6, wherein, when a cancellation of said transaction along with said first security key is made by the computer of said service provider, said settlement amount is transferred to the bank account of said service user from said bank account for settlement, if said first security key received is found to have been registered in said memory means.

8. A method as claimed in claim 6 further comprising the steps of:
after said service provision has been executed, receiving an additional amount that is transferred from the bank account of said service user, registering said additional amount additionally as said settlement information, and if said second security key received from the computer of said service provider is found to have been registered in said memory means, transferring an amount that is obtained by adding said additional amount to said settlement amount to the bank account of said service provider from said bank account for settlement.

9. A settlement system using a security key, comprising:
first means for electronically moving a settlement amount to a bank account of a financial institution from a bank account of a service user;
second means for generating a security key and transmitting it to the computer of said service user;
third means for registering said security key and other settlement information related to a service providing transaction in a memory means;
said first, second and third means being used after said settlement amount has been fixed through an e-commerce as a result of said service providing transaction between said service provider and said service user, and before the service provision is executed to said service user from said service provider;
fourth means for electronically moving said security key to a computer of a service provider from the computer of said service user, after said service provision has been executed; and
fifth means for electronically moving said settlement amount to the bank account of said service provider from the bank account of said financial institution after the service provision has been executed, if said security key received from the computer of said service provider is found to have been registered in said memory means.

10. A settlement system using security keys, comprising:
first means for electronically moving a settlement amount to a bank account of a financial institution from a bank account of a service user;
second means for generating a first security key for a service provider and a second security key for said service user;
third means for transmitting said first security key to the computer of said service provider and said second security key to the computer of said service user respectively;
fourth means for registering said first security key, said second security key and other settlement information related to a service providing transaction in a memory means;
said first, second, third and fourth means being used after said settlement amount has been fixed through an e-commerce as a result of said service providing transaction between said service provider and said service user, and before the service provision is executed to said service user from said service provider;
fifth means for electronically moving said second security key to the computer of said service provider from the computer of said service user, after said service provision has been executed; and
sixth means for electronically moving said settlement amount to the bank account of said service provider from the bank account of said financial institution after said service provision has been executed, if said second security key received from the computer of said service provider is found to have been registered in said memory means.

11. A settlement system using security keys as claimed in claim 10, further comprising:
means for electronically moving said settlement amount, when a cancellation of said transaction along with said first security key is made by the computer of said service provider, to the bank account of said service user from said bank account for settlement, if said first security key received is found to have been registered in said memory means.

12. A settlement system using security keys as claimed in claim 10, further comprising:
means for electronically moving an additional amount, after said service provision has been executed, to the bank account of said financial institution from the bank account of said service user;
means for adding and registering said additional amount as said settlement information; and
means for electronically moving, if said second security key received from the computer of said service provider is found to have been registered in said memory means, an amount that is obtained by adding said additional amount to said settlement amount to the bank account of said service provider from said bank account of said financial institution.

13. A settlement system that executes a settlement after a settlement amount has been fixed through an e-commerce as a result of a service providing transaction between a service provider and a service user, said system using a security key, comprising:
first means for receiving transfer information related to said transaction to confirm the existence of the bank account of said service provider contained in said transfer information;
second means for receiving said settlement amount transferred from the bank account of said service user in a bank account for settlement;
third means for generating a security key to transmit the key to a computer of said service user;
fourth means for registering said security key and other settlement information related to such transaction in a memory means;
said first, second, third and fourth means being used before said service provision is executed to said service user from said service provider and
means for transferring said settlement amount, after said service provision has been executed, to the bank account of said service provider from said bank account for settlement, if said security key received from the computer of said service provider is found to have been registered in said memory means.

14. A settlement system that executes a settlement after a settlement amount has been fixed through an e-commerce as a result of a service providing transaction between a service provider and a service user, said system using security keys, comprising:
first means for receiving transfer information related to said transaction to confirm the existence of the bank account of said service provider contained in said transfer information;
second means for receiving said settlement amount transferred from the bank account of said service user in a bank account for settlement;
third means for generating a first security key for said service provider and a second security key for said service user;
fourth means for transmitting said first security key to a computer of said service provider and said second security key to a computer of said service user respectively;
fifth means for registering said first security key, said second security key and other settlement information related to such transaction in a memory means;
said first, second, third, fourth and fifth means being used before said service provision is executed to said service user from said service provider; and
sixth means for transferring said settlement amount, after said service provision has been executed, to the bank account of said service provider from the said bank account for settlement, if said second security key received from the computer of said service provider is found to have been registered in said memory means.

15. A settlement system using security keys as claimed in claim 14, further comprising:
means for transferring said settlement amount, when a cancellation of said transaction along with said first security key is made by the computer of said service provider, to the bank account of said service user from said bank account for settlement, if said first security key received is found to have been registered in said memory means.

16. A settlement system using security keys as claimed in claim 14, further comprising:
means for receiving an additional amount transferred from the bank account of said service user, after said service provision has been executed, in the bank account of said bank account for settlement;
means for adding and registering said additional amount as said settlement information; and
means for transferring an amount that is obtained by adding said additional amount to said settlement amount to the bank account of said service provider from said bank account for settlement, if said second security key received from the computer of said service provider is found to have been registered in said memory means.

17. A program which allows a computer to execute the following functions:
a first function for receiving transfer information related to a transaction in a computer to confirm the existence of a bank account of a service provider contained in said transfer information,;
a second function for receiving a settlement amount transferred from a bank account of a service user in a bank account for settlement;
a third function for generating a security key to transmit the key to a computer of said service user;
a fourth function for registering said security key and other settlement information related to said transaction in a memory means;
said first, second, third and fourth functions being executed after said settlement amount has been fixed through an e-commerce as a result of said transaction between said service provider and said service user and before the service provision is executed to said service user from said service provider; and
a fifth function for transferring said settlement amount to the bank account of said service provider from said bank account for settlement after said service provision has been executed, if said security key received from the computer of said service provider has been registered in said memory means.

18. A program which allows a computer to execute the following functions:
a first function for receiving transfer information related to a transaction in a computer to confirm the existence of a bank account of a service provider contained in said transfer information;
a second function for receiving a settlement amount transferred from a bank account of a service user in a bank account for settlement;
a third function for generating a first security key for said service provider and a second security key for said service user;
a fourth function for transmitting the first security key to a computer of said service provider and the second security key to a computer of said service user respectively;
a fifth function for registering said first security key, said second security key and other settlement information related to said transaction in a memory means;
said first, second, third, fourth and fifth functions being executed after said settlement amount has been fixed through an e-commerce as a result of said transaction between said service provider and said service user before the service provision is executed to said service user from said service provider; and
a sixth function for transferring said settlement amount to the bank account of said service provider from said bank account for settlement after said service provision has been executed, if said second security key received from the computer of said service provider has been registered in said memory means.

19. A program as claimed in claim 18, further including a seventh function for transferring said settlement amount, when a cancellation of said transaction along with said first security key is made by the computer of said service provider, to the bank account of said service user from said bank account for settlement, if said first security key received is found to have been registered in said memory means.

20. A program as claimed in claim 18, further including:
a seventh function, for receiving an additional amount transferred from the bank account of said service user in the bank account of said bank account for settlement;
a eighth function for adding and registering said additional amount as said settlement information;
a ninth function for transferring an amount that is obtained by adding said additional amount to said settlement amount to the bank account of said service provider from said bank account for settlement, if said second security key received from the computer of said service provider is found to have been registered in said memory means;
said seventh, eighth and ninth functions being executed after said service provision has been executed.
